(19) United States
(12) Patent Application Publication
(10) Pub. No.: US 2006/0113479 A1
(43) Pub. Date: Jun. 1, 2006

(54) Method and apparatus for improving timing resolution of coincident gamma cameras and pet scanners

(76) Inventor: Valera Zavarzin, Newton, MA (US)

Correspondence Address: KATTEN MUCHIN ROSENMAN LLP, 525 WEST MONROE STREET, CHICAGO, IL, 60661-3693, US

(21) Appl. No.: 11/246,958

(22) Filed: Oct. 11, 2005

Related U.S. Application Data
(60) Provisional application No. 60/617,195, filed on Oct. 12, 2004.

(51) Int. Cl. G01T 1/164

(52) U.S. Cl. 250/363.03

(57) ABSTRACT

A method and an apparatus for determining coincidence between gamma rays arriving at a plurality of detector locations in a camera is provided. Gamma ray signals are received in each of two detector locations. In response to the received signals, pulse signals are generated and sent to a single field-programmable logic chip. The field-programmable logic chip is used to calculate a time delay related to times at which the pulse signals were received. An output signal related to the calculated time delay is then generated and sent to a time-delay converter. The time-delay converter generates a delay time stamp. A gate signal is sent to a plurality of analog-to-digital converters, which then digitize gamma ray signals being received at the two detector locations. Finally, the time delay stamp is added to each of the digitized gamma ray signals.

### CROSS-REFERENCE TO RELATED APPLICATIONS

This application claims priority to Provisional U.S. Patent Application No. 60/617,195, filed on Oct. 12, 2004, the contents of which are incorporated herein by reference.

### BACKGROUND OF THE INVENTION

1. Field of the Invention

The present invention relates to the use of positron emission tomography scanners and coincident gamma cameras, and more particularly to methods of improving timing resolution of these devices.

2. Related Art

For positron emission tomography (“PET”) scanners and coincident gamma cameras (broadly referred to herein as “cameras”), images are formed by examining the collection of data about gamma rays produced by radioactive sources and which are detected by detector elements of the cameras. The radioactive sources imaged by these cameras emit two gamma rays that travel in opposite directions at essentially the same time. In order for the data collected by the cameras to be produced into an image, it is necessary for the camera to determine which gamma rays were produced at the same time by the radioactive source (i.e., “coincident gamma rays”). When two gamma rays arrive at detector locations in the camera at the same time, the camera software can represent this event by a single line connecting the two detector locations. The set of lines produced in this manner can be reconstructed by a camera computer in order to form an image of the source distribution. Accordingly, research is ongoing to develop methodologies for determining coincidence between gamma rays arriving at detector locations in the camera.

Previously, attempts have been made to determine coincidence of gamma rays arriving at detectors in cameras with many detector elements. When a detector element in these camera systems detects a gamma ray, an event is recorded in the camera system computer. The event includes the location of the detector element, as well as other information about the event such as the energy collected by the detector. The time that the event occurred is also stored by the camera system computer (“time-stamp”). Another variation is to have multiple detector elements in a group (usually called a “bucket”) send their summed signals to the camera system computer, and have the entire bucket assigned a single time-stamp by the camera system computer. The time-stamps of events can then be reviewed by the camera system computer, and if the time-stamps of the events lie within specified intervals of one another, the events are considered coincident. For example, if a camera system has a 12-nanosecond “window”, events that are time-stamped within 12-nanoseconds of one another are considered coincident.

The determination as to whether gamma ray events are coincident is important when the radioactive source has high strength. When many gamma rays are collected by the camera in a short period of time, the time-stamps assigned to the gamma rays may overlap within the timing window randomly, even when the gamma rays were not truly produced at exactly the same time. Thus, a wide timing window can lead to reduced image quality.

One disadvantage of these previous systems is that the resolution of the timing measurement is limited by the frequency of the time-stamp clock. For example, a very high clock speed of 200 MHz, which is about the practical limit for real printed circuits, is limited to a precision of 5 nanoseconds for the assignment of a time-stamp.

### SUMMARY OF THE INVENTION

In one aspect, the invention provides a method for determining coincidence between gamma rays arriving at a plurality of detector locations in a camera. The method includes the steps of receiving gamma ray signals in each of a first detector location and a second detector location; generating pulse signals in response to the received gamma ray signals; receiving the generated pulse signals in a single field-programmable logic chip; using the field-programmable logic chip to calculate a time delay related to times at which the pulse signals were received; generating an output signal related to the calculated time delay; sending the output signal to a time-delay converter; using the time-delay converter to generate a delay time stamp; sending a gate signal to a plurality of analog-to-digital converters; using the analog-to-digital converters to digitize gamma ray signals being received at the first and second detector locations; and adding the time delay stamp to each of the digitized gamma ray signals. The time delay stamp may be added to each of the digitized gamma ray signals using a low-voltage differential signaling communications link.

The step of using the field-programmable logic chip to calculate a time delay may include the steps of iteratively using data relating to times at which gamma ray signals are received at the respective detector locations to titrate a coincidence window, and using the titrated coincidence window to converge on an optimal time delay value. The field-programmable logic chip may include a field-programmable gate array chip.

In another aspect, the invention provides a method for determining coincidence between gamma rays arriving at a plurality of detector locations in a camera. The method includes the steps of receiving gamma ray signals in each of a first detector location and a second detector location; generating pulse signals in response to the received gamma ray signals; receiving the generated pulse signals in a single microprocessor chip; using the microprocessor chip to calculate a time delay related to times at which the pulse signals were received; generating an output signal related to the calculated time delay; sending the output signal to a time-delay converter; using the time-delay converter,to generate a delay time stamp; sending a gate signal to a plurality of analog-to-digital converters; using the analog-to-digital converters to digitize gamma ray signals being received at the first and second detector locations; and adding the time delay stamp to each of the digitized gamma ray signals. The time delay stamp may be added to each of the digitized gamma ray signals using a low-voltage differential signaling communications link. The step of using the microprocessor chip to calculate a time delay may include the steps of iteratively using data relating to times at which gamma ray signals are received at the respective detector locations to titrate a coincidence window, and using the titrated coincidence window to converge on an optimal time delay value.

In yet another aspect, the invention provides a method for determining coincidence between gamma rays arriving at a plurality of detector locations in a camera. The method includes the steps of receiving gamma ray signals in each of a first detector location and a second detector location; generating pulse signals in response to the received gamma ray signals; receiving the generated pulse signals in a single programmable logic device; using the programmable logic device to calculate a time delay related to times at which the pulse signals were received; generating an output signal related to the calculated time delay; sending the output signal to a time-delay converter; using the time-delay converter to generate a delay time stamp; sending a gate signal to a plurality of analog-to-digital converters; using the analog-to-digital converters to digitize gamma ray signals being received at the first and second detector locations; and adding the time delay stamp to each of the digitized gamma ray signals. The time delay stamp may be added to each of the digitized gamma ray signals using a low-voltage differential signaling communications link. The step of using the programmable logic device to calculate a time delay may include the steps of iteratively using data relating to times at which gamma ray signals are received at the respective detector locations to titrate a coincidence window, and using the titrated coincidence window to converge on an optimal time delay value.

In still another aspect, the invention provides an apparatus for determining coincidence between gamma rays arriving at a plurality of detector locations. The apparatus includes a camera having at least a first detector location and a second detector location; a first discriminator in communication with the first detector location; a second discriminator in communication with the second detector location; a field-programmable logic chip in communication with the first and second discriminators; a time delay converter in communication with the field-programmable logic chip; and a plurality of analog-to-digital converters, each analog-to-digital converter being in communication with the field-programmable logic chip. The camera is configured to receive gamma ray signals in each of the first and second detector locations, and to send the received signals to the first and second discriminators, respectively. Each discriminator is configured to generate and send pulse signals to the field-programmable chip in response to the received gamma ray signals. The field-programmable chip is configured to use the received signals to calculate a time delay related to times at which the pulse signals were received, and to generate an output signal related to the calculated time delay, and to send the output signal to the time-delay converter. The time-delay converter is configured to generate a delay time stamp. The analog-to-digital converters are configured to digitize the gamma ray signals being received at the first and second detector locations. The apparatus further includes a means for adding the time delay stamp to each of the digitized gamma ray signals. The means for adding the time delay stamp to each of the digitized gamma ray signals may include a low-voltage differential signaling communications link.

The field-programmable logic chip may be further configured to iteratively using data relating to times at which gamma ray signals are received at the respective detector locations to titrate a coincidence window, and to use the titrated coincidence window to converge on an optimal time delay value. The field-programmable logic chip may include a field-programmable gate array chip. The camera may include a coincident gamma camera; alternatively, the camera may include a positron emission tomography scanner.

### BRIEF DESCRIPTION OF THE DRAWINGS

FIG. 1 illustrates a block diagram of a gamma camera system for obtaining improved timing resolution according to a preferred embodiment of the invention.

FIG. 2 is a flow chart that illustrates a method of obtaining improved timing resolution for received gamma rays according to a preferred embodiment of the invention.

FIG. 3 illustrates a block diagram of a gamma camera system for obtaining improved timing resolution according to a preferred embodiment of the invention.

### DETAILED DESCRIPTION OF THE INVENTION

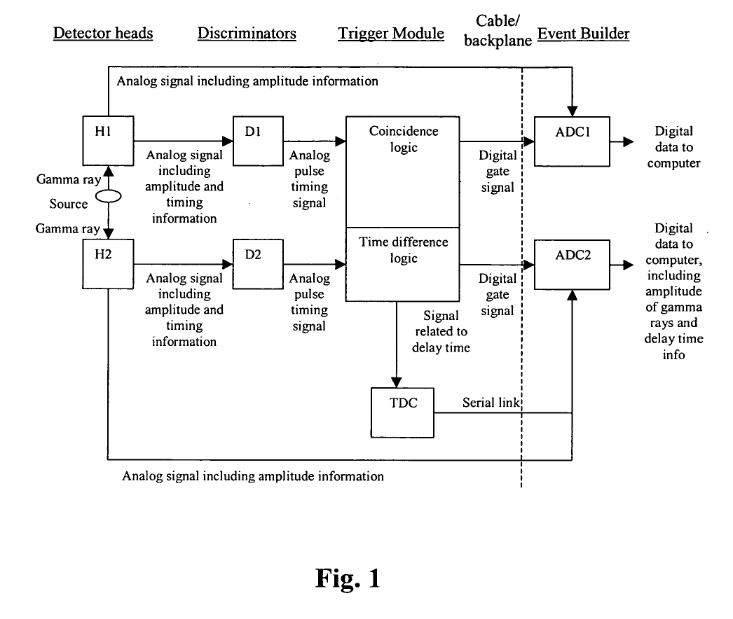

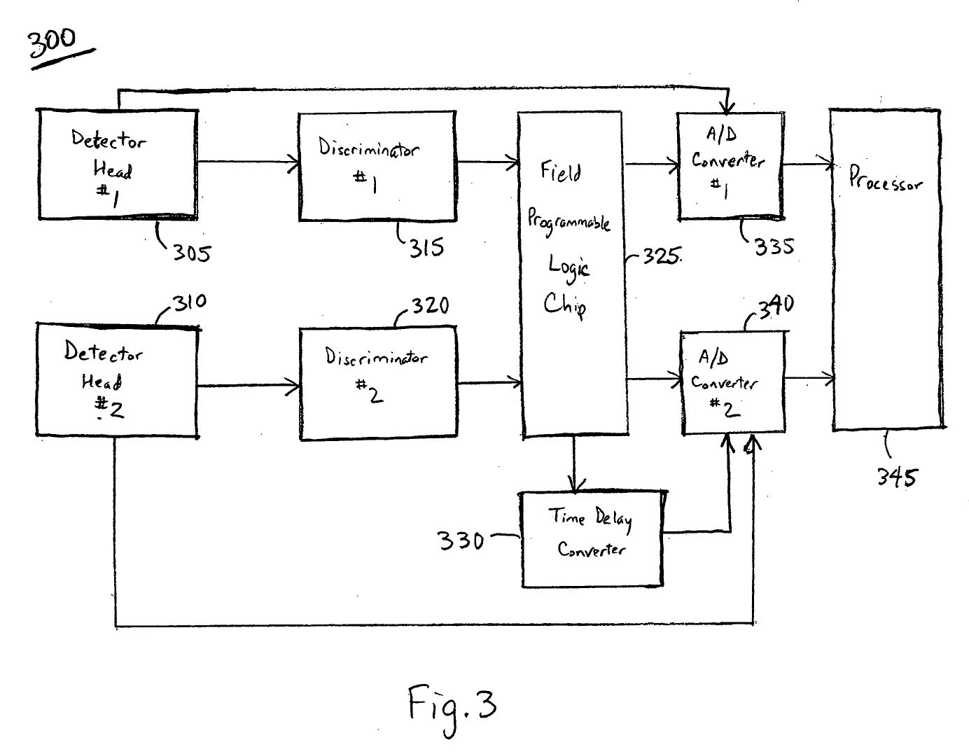

To address these problems, the present inventors have developed a method of obtaining improved timing resolution. Referring to FIGS. 1, 2, and 3, the invention includes a method 200 and an apparatus 300 designed to measure the relative time delay between events collected in one detector head 305 and events collected in a second detector head 310. The time delay is measured with a time-delay converter (“TDC”) 330 that receives signal from a computer chip 325 that contains coincidence logic as well as time difference logic instructions. This computer chip 325 is referred to herein as the “Trigger module”. As shown in FIGS. 1 and 3, the Trigger module 325 receives analog pulse signals from discriminator circuits 315 and 320 that, in turn, respectively receive signals from each of the two heads 305 and 310. Each discriminator circuit 315 and 320 generates an electrical pulse when the analog inputs to the discriminators rise above a certain predetermined threshold and obey certain conditions. For example, the conditions may require that the analog inputs remain below a predetermined maximum value. When two of the discriminators 315 and 320 send pulses to the Trigger module 325, the Trigger module's internal coincidence logic determines whether the pulses arrived within a predetermined timing window, and the internal time difference logic determines the relative delay time between the pulses. The Trigger module 325 then sends an output signal related to the relative delay time to a TDC 330, and also sends a gate signal to analog-to-digital converters (“ADCs”) 335 and 340 to instruct the ADCs 335 and 340 to start digitizing the amplitude of the detector head signals, which are sent directly from the respective detector heads 305 and 310 to the respective ADCs 335 and 340. The output signal may, for example, be a digital signal whose width corresponds to the relative delay time.

The TDC 330 generates a delay time stamp that can be added to the digital signals generated by the ADCs 335 and 340. Because the delay times of interest are usually short (e.g., on the order of a nanosecond), the digital word representing the delay time stamp is short (e.g., less than 8 bits). Because the digital delay time stamp is small, the information can be carried to the ADC modules 335 and 340 via a serial link before the analog-to-digital electronics in the ADC modules have completed the data conversion. In this manner, the invention provides a method of incorporating the TDC data over a fast LVDS (Low-Voltage Differential Signaling) serial link into the datastream without any impact on either the data throughput or EMI properties of the system. LVDS serial links provide very high data bandwidth and extremely low digital noise. The datastream can be either an ADC bank or a dedicated Event Builder. Event Builder is a term for a module or subsystem that logically combines multiple bytes of digital data into a continuous data stream or into large blocks of data.

The relative delay time can be measured by the Trigger module 325 and TDC 330 with extremely high accuracy, for example, to within 0.05 nanoseconds. For this reason, it is possible for the system computer 345 to determine with high accuracy whether the two gamma rays occurred in a very short timing window. For example, if the cameras are equipped with a fast scintillator, the computer 345 can determine whether the two gamma rays occurred within a 0.05 nanosecond window.

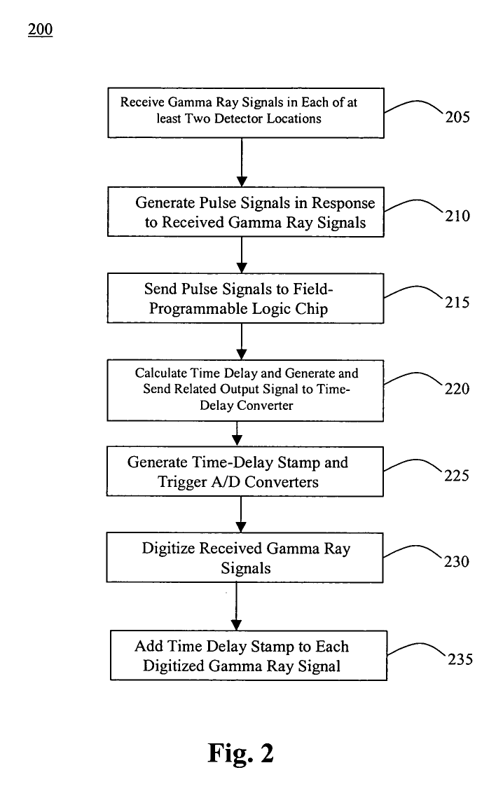

A flowchart that illustrates a method 200 of improving timing resolution for coincident gamma cameras and PET scanners is shown in FIG. 2. In the first step 205, gamma ray signals are received in each of the first and second detector locations 305 and 310, and then sent to the respective discriminators 315 and 320. In the second step 210, discriminators 315 and 320 generate pulse signals in response to the received gamma ray signals. In the third step 215, the discriminators sent the generated pulse signals to the Trigger module 325. Then, at step 220, the Trigger module 325 calculates a time delay and generates an output signal related to the time delay. The output signal is then sent to the TDC 330. At step 225, the TDC 330 generates a time stamp, and the Trigger module 325 sends a gate signal to the ADCs 335 and 340 to trigger them to begin digitizing the received gamma ray signals. Then, the ADCs actually digitize the received gamma ray signals at step 230. Finally, at step 235, the time delay stamp generated by the TDC 330 is added to each of the digitized gamma ray signals.

A similar approach to studying coincident timing has been used in high-energy physics. In this application, which is not known as being applied to medical imaging applications, pulses from two detectors were sent to a TDC, and the signal from the TDC was sent to a computer. In contrast to the high-energy physics application, a preferred embodiment of the present invention implements the coincident logic and delay measurement circuitry for the two detector head inputs in a single Trigger module 325, which typically comprises a single field-programmable logic chip, such as, for example, a field-programmable gate array (“FPGA”) chip. Alternatively, the Trigger module 325 may comprise another type of microprocessor or programmable logic device. The implementation of this circuitry in a single Trigger module 325 provides important advantages, because separation of the coincident logic and delay measurement circuitry into separate physical computer chip components typically introduces electronic jitter errors and delay times, which can reduce coincidence timing accuracy. In a preferred embodiment of the present invention, the Trigger module 325 is programmed to perform both the coincidence detection function and the delay time calculation function within a single set of instructions (i.e., computer program).

Accordingly, the present invention provides a method of processing of time-difference information along with pre-existing trigger signals in the FPGA chip 325, thus eliminating the complexity of multi-pair wire connections. In a preferred embodiment, the Trigger module 325 can handle more than one pair of input signals, so that more than two detector heads, or more than two detectors of other types, can be handled similarly. The system computer 345 can calibrate the individual time offsets for each detector after collecting many detector pairs in the data set by applying an iterative procedure to the time difference data without express knowledge of the individual timing delay of any detector. The timing information can be used in a software algorithm that automatically titrates the coincidence window to converge on an optimal image, because there may not be a single optimal window for all cases.

In another preferred embodiment, the present invention can be applied to a time-of-flight PET system, where the timing delay information can not only reduce the effect of random coincidences, but can also provide some information as to the location of the radioactive source between the detector heads. This information can be applied in the reconstruction process to improve image quality.

While the present invention has been described with respect to what are presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A method for determining coincidence between gamma rays arriving at a plurality of detector locations in a camera, the method comprising the steps of:
receiving gamma ray signals in each of a first detector location and a second detector location;
generating pulse signals in response to the received gamma ray signals;
receiving the generated pulse signals in a single field-programmable logic chip;
using the field-programmable logic chip to calculate a time delay related to times at which the pulse signals were received;
generating an output signal related to the calculated time delay;
sending the output signal to a time-delay converter;
using the time-delay converter to generate a delay time stamp;
sending a gate signal to a plurality of analog-to-digital converters;
using the analog-to-digital converters to digitize gamma ray signals being received at the first and second detector locations; and
adding the time delay stamp to each of the digitized gamma ray signals.

2. The method of claim 1, wherein the time delay stamp is added to each of the digitized gamma ray signals using a low-voltage differential signaling communications link.

3. The method of claim 1, wherein the step of using the field-programmable logic chip to calculate a time delay comprises the steps of:
iteratively using data relating to times at which gamma ray signals are received at the respective detector locations to titrate a coincidence window, and
using the titrated coincidence window to converge on an optimal time delay value.

4. The method of claims 1 or 3, wherein the field-programmable logic chip comprises a field-programmable gate array chip.

5. A method for determining coincidence between gamma rays arriving at a plurality of detector locations in a camera, the method comprising the steps of:
receiving gamma ray signals in each of a first detector location and a second detector location;
generating pulse signals in response to the received gamma ray signals;
receiving the generated pulse signals in a single microprocessor chip;
using the microprocessor chip to calculate a time delay related to times at which the pulse signals were received;
generating an output signal related to the calculated time delay;
sending the output signal to a time-delay converter; using the time-delay converter to generate a delay time stamp;
sending a gate signal to a plurality of analog-to-digital converters;
using the analog-to-digital converters to digitize gamma ray signals being received at the first and second detector locations; and
adding the time delay stamp to each of the digitized gamma ray signals.

6. The method of claim 5, wherein the time delay stamp is added to each of the digitized gamma ray signals using a low-voltage differential signaling communications link.

7. The method of claim 5, wherein the step of using the microprocessor chip to calculate a time delay comprises the steps of:
iteratively using data relating to times at which gamma ray signals are received at the respective detector locations to titrate a coincidence window, and
using the titrated coincidence window to converge on an optimal time delay value.

8. A method for determining coincidence between gamma rays arriving at a plurality of detector locations in a camera, the method comprising the steps of:
receiving gamma ray signals in each of a first detector location and a second detector location;
generating pulse signals in response to the received gamma ray signals;
receiving the generated pulse signals in a single programmable logic device;
using the programmable logic device to calculate a time delay related to times at which the pulse signals were received;
generating an output signal related to the calculated time delay;
sending the output signal to a time-delay converter; using the time-delay converter to generate a delay time stamp;
sending a gate signal to a plurality of analog-to-digital converters;
using the analog-to-digital converters to digitize gamma ray signals being received at the first and second detector locations; and
adding the time delay stamp to each of the digitized gamma ray signals.

9. The method of claim 8, wherein the time delay stamp is added to each of the digitized gamma ray signals using a low-voltage differential signaling communications link.

10. The method of claim 8, wherein the step of using the programmable logic device to calculate a time delay comprises the steps of:
iteratively using data relating to times at which gamma ray signals are received at the respective detector locations to titrate a coincidence window, and
using the titrated coincidence window to converge on an optimal time delay value.

11. An apparatus for determining coincidence between gamma rays arriving at a plurality of detector locations, the apparatus comprising:
a camera, the camera including at least a first detector location and a second detector location;
a first discriminator in communication with the first detector location;
a second discriminator in communication with the second detector location;
a field-programmable logic chip in communication with the first and second discriminators;
a time delay converter in communication with the field-programmable logic chip; and
a plurality of analog-to-digital converters, each analog-to-digital converter being in communication with the field-programmable logic chip and with the camera,
wherein the camera is configured to receive gamma ray signals in each of the first and second detector locations, and to send the received signals to the first and second discriminators, respectively; and
wherein each discriminator is configured to generate and send pulse signals to the field-programmable chip in response to the received gamma ray signals; and
wherein the field-programmable chip is configured to use the received signals to calculate a time delay related to times at which the pulse signals were received, and to generate an output signal related to the calculated time delay, and to send the output signal to the time-delay converter; and
wherein the time-delay converter is configured to generate a delay time stamp; and
wherein the analog-to-digital converters are configured to digitize the gamma ray signals being received at the first and second detector locations; and
wherein the apparatus further comprises a means for adding the time delay stamp to each of the digitized gamma ray signals.

12. The apparatus of claim 11, wherein means for adding the time delay stamp to each of the digitized gamma ray signals comprises a low-voltage differential signaling communications link.

13. The apparatus of claim 11, wherein the field-programmable logic chip is further configured to iteratively using data relating to times at which gamma ray signals are received at the respective detector locations to titrate a coincidence window, and to use the titrated coincidence window to converge on an optimal time delay value.

14. The apparatus of claim 11 or claim 13, wherein the field-programmable logic chip comprises a field-programmable gate array chip.

15. The apparatus of claim 11, wherein the camera comprises a coincident gamma camera.

16. The apparatus of claim 11, wherein the camera comprises a positron emission tomography scanner.
